(19) United States
(12) Patent Application Publication
(10) Pub. No.: US 2007/0111177 A1
(43) Pub. Date: May 17, 2007

(54) Interactive electronic book

(76) Inventor: Andrew Bruce Rifkin, Rolling Hills Estates, CA (US)

Correspondence Address: KONRAD RAYNES & VICTOR, LLP, 315 S. BEVERLY DRIVE, # 210, BEVERLY HILLS, CA, 90212, US

(21) Appl. No.: 11/255,410

(22) Filed: Oct. 20, 2005

(51) Int. Cl. G09B 5/00

(52) U.S. Cl. 434/317

(57) ABSTRACT

Interactive electronic book devices and methods relating thereto are described. One embodiment of an electronic book device relates to a book including a plurality of pages, including printed information relating to a story. The electronic book device also includes a housing including a plurality of user interactive controls positioned thereon. At least one of the user interactive controls is selected from the group consisting of a key, a joystick, and a steering wheel. The book is rigidly coupled to the housing. The electronic book device also includes a controller coupled to the housing, the controller adapted to receive input signals related to the story from the user interactive controls, the controller also adapted to transmit output signals related to the story to a display device spaced a distance away from the housing. Other embodiments are described and claimed.

### BRIEF DESCRIPTION OF THE DRAWINGS

Embodiments are described by way of example, with reference to the accompanying drawings, which are not necessarily drawn to scale, wherein:

FIG. 1 is a view illustrating an interactive electronic book device in accordance certain embodiments of the present invention;

FIG. 2 is a view illustrating certain aspects of an interactive electronic book device including a speaker, controller, and batteries, in accordance certain embodiments of the present invention;

FIG. 3 is a view illustrating certain aspects of an interactive electronic book device including features on pages of the book, in accordance certain embodiments of the present invention; and

FIG. 4 illustrates a computing environment which may be used in accordance with certain embodiments of the present invention.

### DETAILED DESCRIPTION

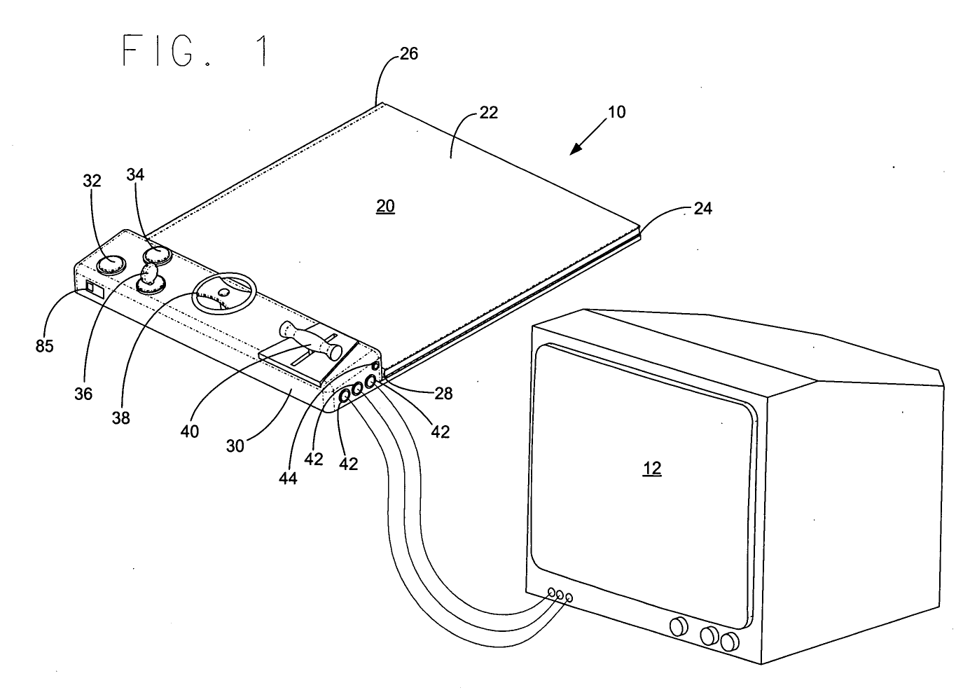

FIG. 1 illustrates an interactive electronic book device 10 that may be connected to a display device 12 in accordance with certain embodiments. The interactive electronic book device 10 includes a story book 20 and a housing 30. The story book 20 may be a conventional book with words, pictures, and the like on one or more pages, and may include a top cover 22 and bottom cover 24 with the pages bound at a spine 26. As seen in FIG. 1, the top cover 22 of the story book portion 20 is closed.

The housing 30 may include various electronic components therein and may be sized to extend away from a lower edge 28 of the book portion 20 to provide space for mounting various user interactive controls, including, but not limited to, buttons 32, 34, key 36, a steering wheel 38, a joystick/accelerator 40, and the like. Such interactive controls may act to provide means for performing on-screen actions relating to the story in the story book 20.

The housing 30 may be formed from a variety of materials, including, but not limited to, polymers, and may be formed to include one or more openings or hollow portions therein into which various elements such as electronics, interactive controls, and power supply features may be positioned. The housing 30 may also include one or more audio/visual connection jacks 42 for connecting to a device such as the display device 12 illustrated in FIG. 1, which may be a computer monitor, television, or other type of display device. The housing 30 may also include a power jack 44 to permit the story book to be plugged into a wall socket or other power supply if desired. In addition, a power on/off switch 85 may be present if desired, and positioned, for example, on the housing 30. In certain embodiments, the key 36 or one of the buttons 32, 34 may act as an on/off switch for various aspects (e.g., power, game start/stop, game reset, etc.) of the device.

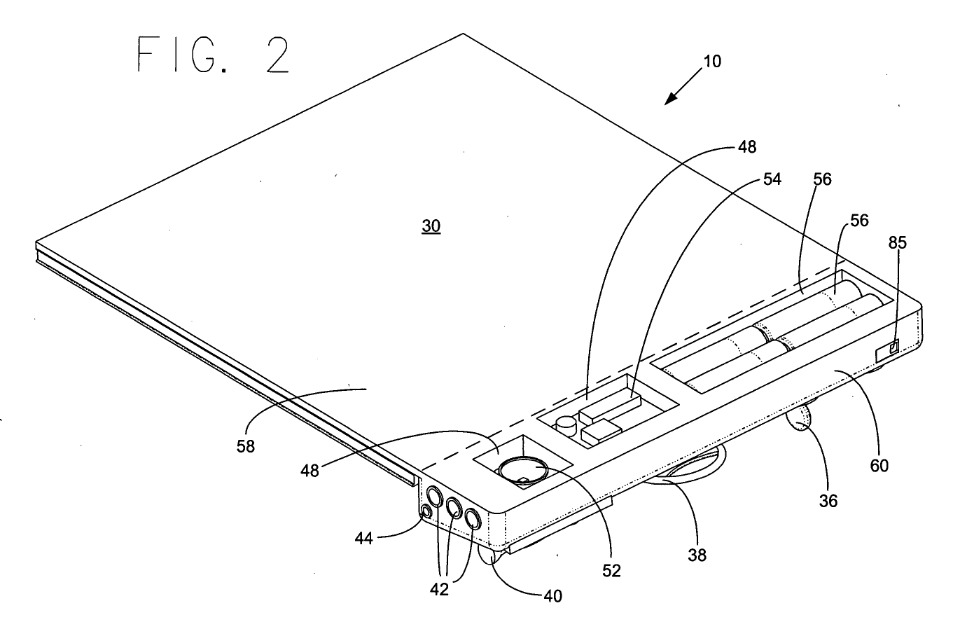

FIG. 2 illustrates a view of the bottom of the interactive electronic book device 10, in accordance with certain embodiments. The housing 30 includes coverable openings 46, 48, and 50 formed therein. The opening 46 is sized to accept a speaker 52. The opening 48 is sized to accept electronic components such as controller 54, which may be coupled to the user interactive controls such as the buttons 32, 34, key 36, steering wheel 38, and the joystick/accelerator 40. The controller 54 may include or be coupled to one or more of a variety of components, including, but not limited to, memory, a sound card, and a microprocessor. The controller 54 may include the necessary hardware and software to implement interactive activities with the user relating to the story and may also include other information relating to implementation of various operations, games, etc. The opening 50 is sized to accept one or more batteries 56.

In certain embodiments, the story book 20 may be coupled to the housing 30 using a suitable connector to ensure a rigid connection. Alternatively, a suitable adhesive may be used to couple the story book 20 to the housing 30.

In the embodiment illustrated in FIG. 2, the housing 30 includes a support portion 58 and a control portion 60, which are separated in FIG. 2 by a dotted line. The support portion 58 is adapted to support the story book 20, and the control portion 60 is adapted to contain the user interactive controls (e.g., buttons 32, 34, key 36, steering wheel 38, joystick/accelerator 40), the connection jacks 42, the power jack 44, the on/off switch 85, the speaker 52, the controller 54, and the batteries 56. The support portion 58 and control portion 60 of the housing 30 may be formed from a single body or alternatively may be formed from a plurality of bodies coupled together. Alternatively, some of the features shown in the control portion 60 could be moved to different locations in the control portion 60 or even to locations in the support portion 58, if desired.

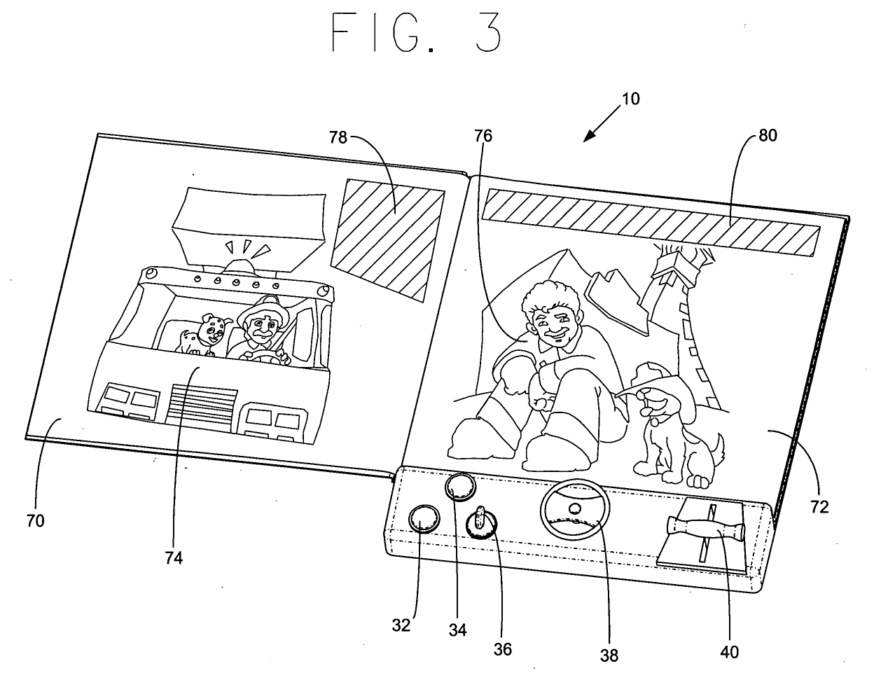

FIG. 3 illustrates the interactive electronic story book 10 with the story book 20 opened to show an example of pages 70, 72 in the book. The pages 70, 72 may include story artwork 74, 76 and story text areas 78, 80 positioned in various locations thereon. As illustrated in the embodiment of FIG. 3, the various controls (buttons 32, 34, key 36, steering wheel 38, joystick/accelerator 40) are positioned adjacent to a lower end of the page 72. Alternatively, the position of the various user interactive controls, relative to the book portion 20, may be modified, if desired.

In certain embodiments, the interactive electronic book device 10 and the display device 12, in combination, may be used for entertainment or educational purposes. Games may include, but are not limited to, coloring, driving, puzzle solving, building scenes, and the like. Such games are preferably related to the story in the story book 20. The interactive electronic story book 10 may in certain embodiments be coupled to the display device 12 through audio/visual connection jacks 42. Alternatively, some other suitable type of connection to a display may be utilized, including, but not limited to, a suitable wireless connection. The housing 30 includes the controller 54 and the various interactive controls, such as buttons 32, 34, steering wheel 38, joy stick 40, and the like, which can be manipulated by the user to control on-screen images and sounds. In one embodiment, one of the buttons 32, 34 may be used to control the playback of the text on the pages of the story book 20. For example, the user may use one of the interactive controls, such as the joystick 40, to direct an on-screen cursor on the display device 12 to a location and then press one of the buttons 32, 34 to notify the controller 54 that a manual page turn has taken place. In another aspect of certain embodiments, the user may be prompted to turn the page of the story book 20 by an audible sound or by a visual cue on the display device 12.

In another example illustrating the use of the interactive controls, the story in the story book 20 may include a scene of driving a car along a road. When the steering wheel 38 is turned by the user, the controller 54 receives an input signal and then generates an output signal that is transmitted to the display 12, that shows a car driving along a road in the direction the user turns the steering wheel 38.

In certain embodiments, the controller 54 transmits a signal to the display 12 that provides a representation of the physical controls on the housing 30 on the display device 12, thus providing an intuitive user interface for interacting with the story in the story book 20. In addition, the same interactive controls may be used for different actions. For example, a steering wheel may be for driving a car in relation to one aspect of the story and for riding a horse along a country trail in relation to another aspect of the story.

In another embodiment, one or more of the electronic components, including, but not limited to the speaker 52, and one or more of the buttons 32, 34, may be powered while the book is not connected to the display device 12, enabling the user to listen to the story while turning the pages of the story book 20.

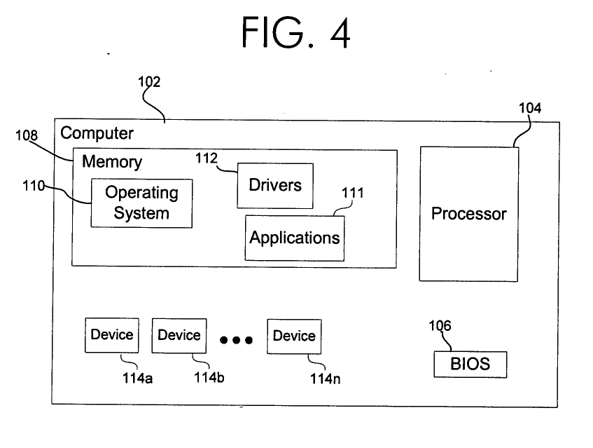

FIG. 4 illustrates one example of a computing environment which may be used with the described embodiments. In this embodiment, the controller 54 may comprise a computer 102 which includes a processor 104 (such as one or more central processing units (CPU)), a basic input/output system (BIOS) 106 including code executed by the processor 104 to initialize and control various computer 102 components (e.g., input sensor circuits, and music and speech synthesizer output circuits) during a boot sequence. Other suitable computer components may also be included in various embodiments. The computer 102 includes a memory 108, comprising one or more volatile memory devices, such as volatile random access memory (RAM), in which an operating system 110, an application 111, and one or more drivers 112, such as a device driver interfacing with an attached device 114a, 114b . . . 114n, may be loaded into the memory 108 implementing a runtime environment. In some applications, the memory 108 may further include nonvolatile memory (e.g., a flash memory, Electronically Erasable Programmable Memory (EEPROM), optical disk drives, magnetic disk drives etc.) for storing data including, but not limited to, application data, story part data, speech data, music data, and game data.

Each device 114a, 114b, . . . 114n may comprise any type of Input/Output (I/O) device, such as music and speech synthesizer circuits, etc. In other embodiments, the devices 114a, 114b, . . . 114n may comprise a hard disk drive, or a video chipset, for example, which may be integrated on the computer 102 motherboard or on an expansion card inserted in an expansion slot on the computer 102 motherboard. The BIOS 106 may be implemented in firmware in a non-volatile memory device on the computer 102 motherboard, such as a Flash memory, Read Only Memory (ROM), Programmable ROM (PROM), etc. The BIOS 106 code indicates the sequence of the boot operations. The operating system 110 may comprise a suitable operating system, such as a Microsoft® Windows® operating system, Linux™, Apple® Macintosh®, etc. (Microsoft and Windows are registered trademarks of Microsoft Corporation, Apple and Macintosh are registered trademarks of Apple Computer, Inc., and Linux is a trademark of Linus Torvalds). It is appreciated that the controller 54 may comprise a variety of computing devices known in the art, and any suitable CPU or processor 104 or operating system may be used.

The described operations may be implemented as a method, apparatus or article of manufacture using standard programming and/or engineering techniques to produce software, firmware, hardware, or any combination thereof. The term “article of manufacture” as used herein refers to code or logic implemented in a tangible medium, where such tangible medium may comprise hardware logic (e.g., an integrated circuit chip, Programmable Gate Array (PGA), Application Specific Integrated Circuit (ASIC), etc.) or a computer readable medium, such as magnetic storage medium, volatile and non-volatile memory devices (e.g., EEPROMs, ROMs, PROMs, RAMs, DRAMs, SRAMs, firmware, programmable logic, etc.). Code in the computer readable medium may be accessed and executed by a processor. The tangible medium in which the code or logic is encoded may also comprise transmission signals propagating through space or a transmission media, such as an optical fiber, copper wire, etc. The transmission signal in which the code or logic is encoded may further comprise a wireless signal. Additionally, the “article of manufacture” may comprise a combination of hardware and software components in which the code is embodied, processed, and executed. Of course, those skilled in the art will recognize that many modifications, additions, and deletions may be made to these configurations without departing from the scope of the present description, and that the article of manufacture may comprise any suitable information bearing medium.

While certain exemplary embodiments have been described above and shown in the accompanying drawings, it is to be understood that such embodiments are merely illustrative and not restrictive. A variety of modifications, additions, and deletions may be made to the above embodiments. For example, the size and shape of the housing 30 may be modified. While the housing 30 described above and illustrated in FIGS. 1-3 is sized to have an area that permits the entire bottom surface of the story book 20 to be on the housing 30, in certain alternative embodiments, the housing may be shaped so that only a portion of the story book 20 is on the housing. In addition, other types of suitable interactive controls may be present (for example, a trackball), and the interactive controls may take different shapes and configurations than those illustrated in the figures. Other changes may also be made by those having ordinary skill in the art.

What is claimed:

1. An electronic book device, comprising:
a book including a plurality of pages, including printed information relating to a story;
a housing including a plurality of user interactive controls positioned thereon, wherein at least one of the user interactive controls is selected from the group consisting of a key, a joystick, and a steering wheel;
the book being rigidly coupled to the housing; and
a controller positioned in the housing, the controller adapted to receive input signals related to the story from the user interactive controls, the controller also adapted to transmit output signals related to the story to a display device spaced a distance away from the housing.

2. The electronic book of claim 1, wherein the controller is also adapted to transmit output signals to the display that produce on the display a visual representation of at least some of the user interactive controls on the housing.

3. The electronic book device of claim 1, further comprising a speaker positioned in the housing and adapted to transmit an audio signal in response to an input from one or more of the interactive controls.

4. The electronic book device of claim 1, wherein the book includes a front and a back cover, and the back cover is coupled to the housing.

5. The electronic book device of claim 1, wherein the housing has a larger surface area than the back cover of the book.

6. The electronic book device of claim 1, wherein the housing includes a plurality of batteries positioned therein.

7. The electronic book device of claim 1, wherein the controller includes a transmitter to transmit the output signals to the display, and the transmitter is selected from the group consisting of a wired transmitter and a wireless transmitter.

8. An electronic book device; comprising:
a book including a plurality of pages, including printed information relating to a story;
a housing including a plurality of user interactive controls positioned thereon;
the book being rigidly coupled to the housing;
a controller coupled to the housing, the controller adapted to receive input signals related to the story from the user interactive controls, the controller also adapted to transmit output signals related to the story to a display device spaced a distance away from the housing; and
a speaker positioned in the housing.

9. The electronic book device of claim 8, wherein the controller is also adapted to transmit output signals to the display that produce on the display a visual representation of at least some of the user interactive controls on the housing.

10. The electronic book device of claim 8, wherein the plurality of controllers includes at least one of a key, a joystick, and a steering wheel.

11. The electronic book of claim 8, wherein the controller includes memory including information relating to one or more games that are related to the story.

12. The electronic book of claim 11, wherein the interactive controls are adapted to be used in connection with the one or more games in the memory.

13. The electronic book of claim 12, wherein the one or more games are selected from the group consisting of coloring, racing, driving, riding, puzzle solving, and building scenes.

14. The electronic book device of claim 8, wherein the book includes a front and a back cover, and the back cover is coupled to the housing.

15. The electronic book device of claim 14, wherein the housing has a larger surface area than the back cover of the book.

16. The electronic book device of claim 8, wherein the housing includes a plurality of batteries positioned therein.

17. The electronic book device of claim 8, further comprising a display device spaced a distance away from the housing.

18. A method comprising:
providing an electronic book device including a plurality of pages of printed information relating to a story and a housing coupled to the plurality of printed pages, the housing including a plurality of user interactive controls, the plurality of user interactive controls including at least one control selected from the group consisting of a key, a joystick, and a steering wheel;
generating input signals in the electronic book device in connection with a user's manipulation of at least one of the user interactive controls in relation to the story, and delivering the input signals to a controller in the electronic book device; and
generating output signals in the controller in response to the input signals, the output signals including information relating to the story, and transmitting at least some of the output signals from the controller in the electronic book device to a display device spaced a distance away from the electronic book device.

19. A method according to claim 18, wherein the controller in the electronic book device also transmits signals to the display device that produce on the display a visual representation of at least some of the user interactive controls on the housing.

20. A method according to claim 18, wherein the controller in the electronic book also transmits signals to a speaker positioned in the housing of the electronic book.

21. A method according to claim 18, wherein the transmitting at least some of the output signals from the controller in the electronic book device to a display device is carried out using a method selected from the group consisting of wired transmission and wireless transmission.

22. A method according to claim 18, wherein the user's manipulation of at least one of the user interactive controls in relation to the story includes playing a game related to the story.
